(19) United States
(12) Patent Application Publication
(10) Pub. No.: US 2007/0093993 A1
(43) Pub. Date: Apr. 26, 2007

(54) End-to-end design of electro-optic imaging systems using backwards ray tracing from the detector to the source

(76) Inventor: David G. Stork, Portola Valley, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/256,563

(22) Filed: Oct. 20, 2005

(51) Int. Cl. G06F 17/10

(52) U.S. Cl. 703/2

(57) ABSTRACT

A unified design strategy takes into account different subsystems within an overall electro-optic imaging system. In one implementation, the design methodology predicts end-to-end imaging performance using a spatial model for the source and models for the optical subsystem, the detector subsystem and the image processing subsystem. The image produced by the detector subsystem is estimated by tracing rays backwards from the detector subsystem through the optical subsystem to the source. This image can then be propagated through the digital image processing subsystem to model the entire electro-optic imaging system. The optical subsystem is designed taking into account the entire system.

### BACKGROUND OF THE INVENTION

1. Field of the Invention

This invention relates generally to the design of electro-optic imaging systems, and more particularly, to the “end-to-end” design of these systems based in part on simulating the optical subsystem by ray tracing from the detector back to the source.

2. Description of the Related Art

Electro-optic imaging systems typically include an optical subsystem (e.g., a lens assembly), an electronic detector subsystem (e.g., CCD detector array) and a digital image processing subsystem (e.g., typically implemented in dedicated chips or software). Traditional methods for designing these systems generally involve two discrete stages. First, the optical subsystem is designed with the goal of forming a high quality intermediate optical image of the source (subject to cost, physical and other non-imaging constraints). Next, after the optical subsystem has been designed, the digital image processing subsystem is designed to compensate for remaining defects in the sampled optical image.

The two design stages typically occur with very little coordination between the optical designer and the image processing designer. The separation of these stages is a reflection of the significant differences between the fields of optics and image processing in their methods, tools, goals and constraints. For example, each field covers a large swath of potential applications but there typically is little overlap between the two fields other than the design of electro-optic imaging systems. The design of conventional microscopes, telescopes, eyeglasses, etc. typically does not consider any significant image processing. Likewise, areas of image processing such as compression, computer graphics, and image enhancement typically do not involve any significant optics. As a result, each field has evolved independently of the other and with its own unique terminology, fundamental science, best practices, and set of tools. In general, the familiarity required to master each of these domains hinders a unified perspective to designing electro-optic imaging systems. One important challenge to a unified perspective is the lack of a common language with which to describe the problems and approaches between the two distinct fields. One prominent example can be seen in the thinking about the fundamental conceptual elements associated with each field. Optical designers deal with rays of light and passive optical elements whereas image processers deal with bytes of information and active algorithms. The laws and constraints governing these two fundamental classes of entities differ in numerous ways.

One drawback to the traditional design approach just outlined is that synergies between the optical subsystem and the digital image processing subsystem are often overlooked. The optical designer creates the “best” optical subsystem without knowledge of the digital image processing subsystem. The image processer creates the “best” digital image processing subsystem without the ability to modify the previously designed optical subsystem. These subsystems are then concatenated to form the electro-optic imaging system. The concatenation of two independently designed “best” subsystems may not yield the “best” overall system. There may be unwanted interactions between the two independently designed subsystems and potential synergies between the two subsystems may go unrealized.

Another drawback to the traditional design approach is that information about the source may not be fully utilized in the design process. For example, complex three-dimensional models of the source, such as may be generated in connection with computer graphics, typically cannot be utilized by traditional optical design software. As another example, traditional optical design software typically also cannot take advantage of statistical models of variations in the source. This drawback can be especially severe for special purpose electro-optic imaging systems where the intended class of sources has special optical properties, or where the output is not an image but instead a symbolic representation of the source, for instance a barcode number.

Thus, there is a need for design approaches based on an end-to-end design of the electro-optic imaging system, especially where the entire electro-optical system is considered as a whole and information about the source is incorporated into the design process.

### SUMMARY OF THE INVENTION

The present invention overcomes the limitations of the prior art by providing a unified design strategy that takes into account different subsystems within the overall electro-optic imaging system. In one implementation, the design methodology predicts end-to-end imaging performance using models for the source, the optical subsystem, the detector subsystem and the digital image processing subsystem. The optical subsystem is then designed taking into account these other subsystems. For example, the optical subsystem may be designed based on a post-processing performance metric that takes into account the effects of the image processing. Unlike in conventional approaches, the intermediate optical image produced by the optical subsystem is not required to be high image quality since, for example, the image may be subsequently improved by the digital image processing subsystem.

The design approach includes modeling the propagation of signal from the source through the optical subsystem, the detector subsystem and the digital image processing subsystem. This modeling includes tracing rays from the detector subsystem backwards through the optical subsystem to the source and then modeling propagation of the signal from the source to the detector subsystem based on the backwards ray trace and on a spatial (and/or temporal) model of the source.

For example, assume that the detector subsystem includes an array of detectors, with each detector producing a pixel of an image. In one implementation, the pixel signal at a specific detector is estimated by tracing rays from the detector cell backwards through the optical subsystem to the source. The points where the backwards traced rays intersect various source objects are referred to as source points, and the source points are modeled as making contributions to the pixel. The overall pixel signal is estimated by combining the contributions from the different source points. For example, if some of the backwards traced rays from a detector intersect light source 1, other rays reflect off a mirror to light source 2, and the remaining rays intersect light source 3, then the pixel produced by that detector can be estimated as a combination of the contributions from the three light sources.

The intersection of the backwards traced rays and the source will depend in part on the spatial model of the source. The specifics of the spatial model will depend on the particular application. For example, the spatial model can be three-dimensional. In one implementation, the three-dimensional model is computer-generated. The model could also be statistical in nature. The spatial model can also account for different variations, such as variations due to motion of the source, variations in a position of the source, variations in illumination of the source and noise variations.

Propagation through the digital image processing subsystem will depend in part on the design space (i.e., the type of digital image processing being implemented). For example, the design space can be limited to digital image processing subsystems that restore degradation caused by the point spread function of the optical subsystem and/or the detector subsystem. It can also be limited to linear techniques or certain classes of linear techniques. Linear techniques are more likely to have a closed form solution or other solutions that are well behaved and that can be calculated in an efficient manner. However, the invention is not limited to just linear techniques.

The post-processing performance metric will also vary by application. A preferred digital image performance metric is the mean square error between an ideal image of the source and the image produced by propagation of signal from the source through the electro-optic imaging system. For applications where the end goal is some sort of recognition (e.g., character recognition or barcode reading), the post-processing performance metric may be a measure of the accuracy of recognition, for example the error rate, rate of false positives, etc.

One advantage of this approach is that the resulting electro-optic imaging system may achieve the same system performance as a traditionally designed system, but possibly with fewer components, smaller “footprint” (spatial extent), lower cost, faster development time or less sensitivity (e.g., to manufacturing or environmental variations). This is because the intermediate optical image is not required to be of high image quality, thus opening up new areas in the design space. In these designs, the overall system performance may be the same or better than that of a traditionally designed system, even though the optical subsystem may form an intermediate optical image that is significantly worse in image quality than that formed by the traditionally designed optical subsystem. In these new designs, the optical subsystem may introduce significant aberrations in the intermediate optical image so long as these are adequately corrected by the digital image processing subsystem.

Other aspects of the invention include software and tools to implement the design methods described above, and devices, systems and subsystems created by this design approach.

### BRIEF DESCRIPTION OF THE DRAWINGS

The file of this patent or application contains at least one drawing executed in color. Copies of this patent or patent application publication with color drawings will be provided by the USPTO upon request and payment of the necessary fee. The invention has other advantages and features which will be more readily apparent from the following detailed description of the invention and the appended claims, when taken in conjunction with the accompanying drawings, in which:

FIG. 1 is a block diagram illustrating the problem of designing an electro-optic imaging system.

FIG. 2 is a flow diagram illustrating a method for designing an electro-optic imaging system according to the present invention.

FIG. 3 is a diagram illustrating backwards ray tracing according to the invention.

FIGS. 4A-4G are simulated images of the situation shown in FIG. 3.

FIGS. 5A-5B are simulated images of a barcode tipped at different angles.

### DETAILED DESCRIPTION OF THE PREFERRED EMBODIMENTS

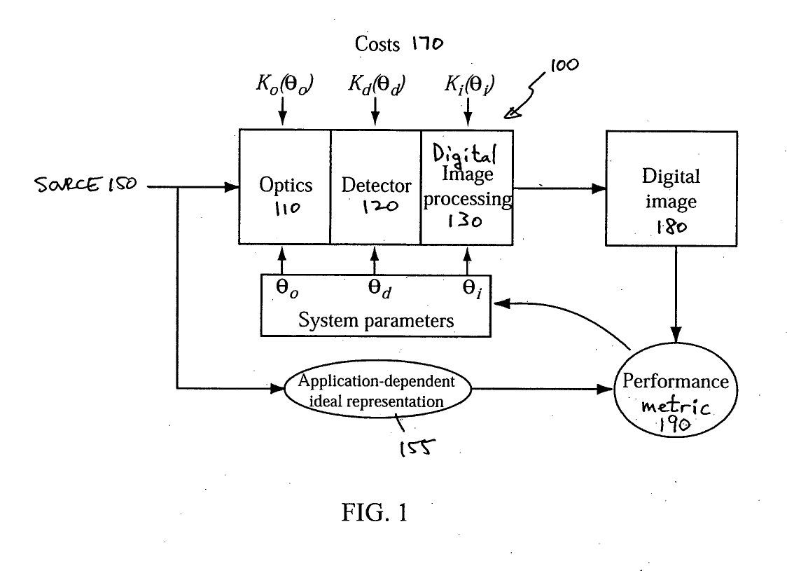

FIG. 1 is a block diagram illustrating the problem of designing an electro-optic imaging system 100. The imaging system 100 includes an optical subsystem 110, detector subsystem 120 and digital image processing subsystem 130. The imaging system 100 is intended to image a source 150 and produces digital image 180. The general design problem is to design the imaging system 100 to “optimize” its overall performance, subject to certain constraints. In many cases, the goal of optimization is to produce a digital image 180 which matches the application-specific idealized version 155 of the input source.

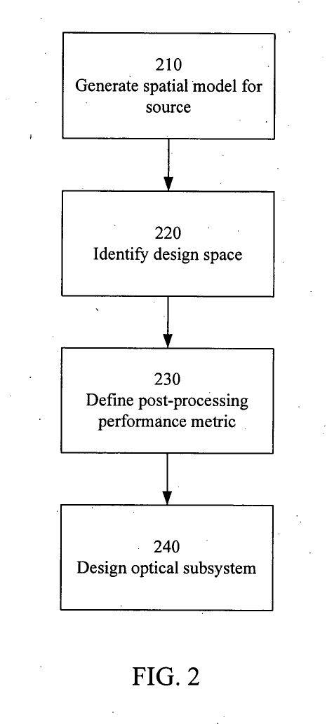

FIGS. 1 and 2 illustrate an example method for designing an electro-optic imaging system 100 according to the present invention. Referring to FIG. 2, the design method includes generating 210 a spatial model of the source 150. The spatial model of the source may be derived for a specific situation, empirically measured, based on previously developed models or otherwise provided. Illumination, radiometry and geometry are factors that may be included in the source model. The spatial model may have a statistical aspect to account for variations in the source, for example variations due to motion of the source, variations in a position of the source, variations in illumination or noise variations. Further examples will be described below.

The design space for the electro-optic imaging system is also defined 220. In FIG. 1, each of the subsystems is defined by its parameters θₒ, θ_{d} and θᵢ;, respectively. For example, the design space for the optical subsystem 110, described by the vector θₒ, may be defined by number, type and size of lenses, radii of curvature, stops, etc. The design space for the detector subsystem 120, described by the vector θ_{d}, may parameterize the number of pixels, detector spacing, fill factor, bandwidth, pixel geometry, etc. The design space for the digital image processing subsystem 130, described by the vector θᵢ, may identify the type(s) of digital image processing to be applied and parameters for that type of processing (e.g., linear or nonlinear filters, number of taps, tap weights, etc). Various non-imaging constraints or costs 170 associated with the designs may also be defined. The size of the design space of each subsystem will vary depending on the application. In some cases, there may be much latitude in designing a subsystem. In other cases, the design of the subsystem may be tightly constrained or even pre-defined (e.g., if the detector array is selected a priori).

A post-processing performance metric 190 is also defined 230. The performance metric is post-processing in the sense that it is based on performance after image processing rather than before image processing. For examples, measures of the wavefront error or spot size of the intermediate optical image produced by the optical subsystem alone may be conventional error metrics for the optical subsystem but they are not post-processing performance metrics. In FIG. 1, the post-processing performance metric 190 is based on a comparison of the digital image 180 produced by the imaging system 100 compared to the ideal digital image 155.

In many design situations, the image 180 produced by the system is calculated by modeling propagation of the source characteristics 150 through the subsystems 110, 120 and 130. In this particular case, propagation is modeled based on tracing rays from the detector subsystem 120 (e.g., from pixels of a detector array) backwards through the optical subsystem 110 to the source 150. The backwards ray trace and the spatial model of the source are used to model forward propagation of signal from the source 150 through the optical subsystem 110 to the detector subsystem 120, as will be described in further detail below.

The design step 240 can be described as selecting a design within the design space that optimizes the post-processing performance metric 190, possibly subject to certain constraints (e.g., limits on certain costs 170). The optical subsystem 110 and the digital image processing subsystem 130 preferably are designed together, rather than sequentially as is the case in conventional design approaches. Mathematically, using the notation of FIG. 1, the design step can be described as selecting the system parameters θₒ, θ_{d} and θᵢ to directly optimize the performance metric, possibly subject to certain constraints on the costs 170. For example, an image-based post-processing performance metric 190 may be optimized subject to a maximum financial cost. Alternately, the financial cost may be minimized subject to some minimum acceptable post-processing performance metric 190 for the digital image 180.

A number of optimization algorithms can be used. For some linear cases, parameters may be solved for analytically or using known and well-behaved numerical methods. For more complicated cases, including certain nonlinear cases, techniques such as expectation maximization, gradient descent and linear programming can be used to search the design space.

Note that in both FIGS. 1 and 2, there is no requirement for the optical subsystem 110, the detector subsystem 120 or the digital image processing subsystem 130, taken alone, to be optimal. It is quite possible for these subsystems to exhibit less than optimal performance when considered alone, while the overall electro-optic imaging system 100 still exhibits good or even optimal performance. This is in direct contrast to conventional design methods where, for example, the optical subsystem 110 typically is designed by directly optimizing the image quality of the intermediate optical image formed by it. For example, the optical subsystem 110 may be designed based directly on minimizing the RMS wavefront error or the RMS spot size. In contrast, for the design approach of FIG. 2, the intermediate optical image formed by the optical subsystem 110 may have worse image quality (e.g., as measured by wavefront error or spot size), which is then corrected by the digital image processing subsystem 130. The optical subsystem 110 is not designed based directly on improving the image quality of the intermediate optical image. Rather, it is designed based directly on improving the post-processing performance metric 190. The optical subsystem 110 preferably is designed jointly with the digital image processing subsystem 130, based directly on optimizing the post-processing performance metric 190.

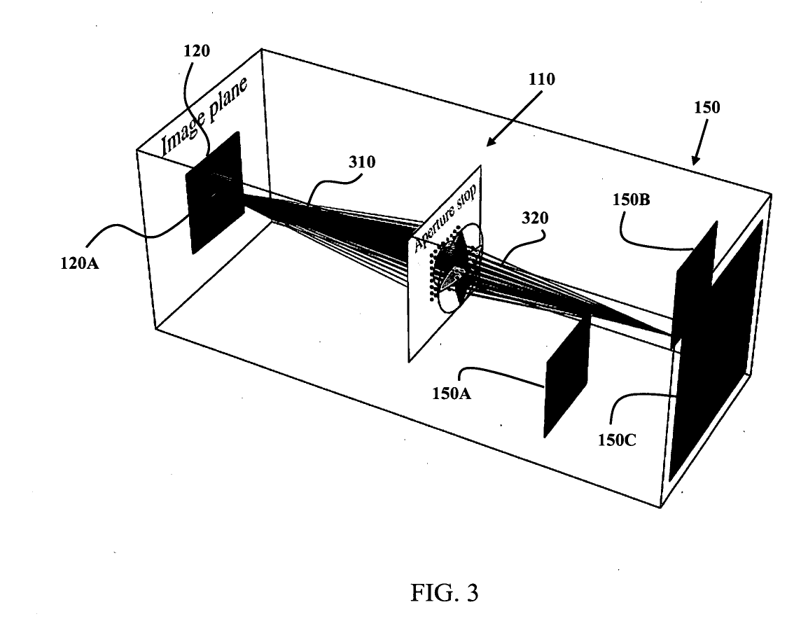

FIG. 3 provides further descriptions of examples of models of the source 150, optical subsystem 110, detector subsystem 120 and digital image processing subsystem 130. One specific model (but not the only model) is described. For each subsystem, important conceptual elements are described as well as the simplifying modeling assumptions that are used in later simulations.

FIG. 3 shows one approach for simulating propagation of signal from the source 150 through the optical subsystem 110 to the detector subsystem 120. In this example, the optical subsystem 110 is shown as a single lens with a square aperture, and the detector subsystem 120 is a square detector array. The source 150 includes a red square 150A and a green square 150B at different positions and depths, with a large distant blue background 150C. In a physical system, the source objects 150 would generate light, which would pass through the lens and aperture stop onto the image plane, for instance a CCD sensor array.

In this approach, however, rays are traced in the backwards direction from the detector array 120 to the source 150. The detector array 120 includes an array of detectors, and one or more detectors in the array are used to produce each pixel of the captured image. In some detector arrays, one detector is used to produce each pixel. In other detector arrays, multiple detectors (e.g., separate red, green and blue detectors) are used to produce each pixel. Regardless of the array geometry, rays are traced from the detector(s) corresponding to a pixel backwards through the optical subsystem 110 to the source 150. The pixel (e.g., its color and brightness) is then estimated based on the backwards ray trace and the spatial model of the source.

FIG. 3 shows a pixel towards the center of the image plane being backwards ray traced. The detector 120A is the element that generates the pixel in question. Rays 310 originate from the detector 120A and are ray traced backwards through the aperture stop and lens 110 and onward to the source 150. Some of the rays hit the red square 150A, some hit the green square 150B and some hit the blue background 150C. Each source point intersected by each ray makes a contribution to the overall pixel produced by the detector 120A. These image contributions are combined to estimate the overall pixel. In one approach, the relative proportion of the rays that intersect each of the source objects 150A-150C determines the “color” that the detector 120A sees and the pixel is estimated by forming a weighted average of the image contributions from the rays. In short, this approach “works backwards” from the flow of light in the spatial model of the source, plus the optical subsystem. The same process is repeated for each pixel. In this way, the entire captured image can be estimated.

In FIG. 3, each ray that is traced backwards from detector 120A results in a single point of intersection with a source object 150. None of the rays split into multiple rays as part of the backwards ray trace. This is done to simplify FIG. 3 but is not required. For example, if a backwards traced ray hits a diffuse surface, it may be split into multiple rays, each of which is further backwards ray traced. The multiple rays account for the diffuse nature of the surface.

The image estimated based on the backward ray trace can then be used as input to the digital image processing subsystem 130. The parameters θᵢ; for the digital image processing subsystem 130 can be designed based on the estimated image in comparison to the ideal image 155. In one approach, a set of different sources (e.g., a set of barcodes) are used to produce a set of backwards ray traced images, with corresponding ideal images. These two sets can then be used to generate statistical models, from which the parameters θᵢ for the digital image processing subsystem 130 can be determined. Once the parameters θᵢ are determined, the image based on backwards ray tracing can be propagated through the digital image processing subsystem 130 to produce the digital image 180. Comparison to the ideal image 155 yields the performance metric 190 for this particular trial design of optical subsystem 110 and digital image processing subsystem 130. This process can be iterated to design an optical subsystem 110 that optimizes the performance metric 190.

In more detail, the backwards ray bundle originating from each detector can have different distributions. Each detector occupies a finite area and subtends a finite solid angle relative to the exit aperture of the optical subsystem 110. In one approach, rays are distributed evenly across this area and solid angle but they may be weighted differently. For example, rays that strike the detector at a near-normal angle may be weighted more heavily than those that strike at a steeper angle. In an alternate approach, all rays are given equal weighting but they are unevenly distributed across the detector area and solid angle. For example, there may be a denser ray distribution near normal compared to at steeper angles.

The image contribution from each intersected source point can also be determined in different ways. The image contribution preferably accounts for the directionality of the source (e.g., if the source has a Lambertian distribution oriented in a certain direction) as well as the source color and intensity (including intensity falloff with distance).

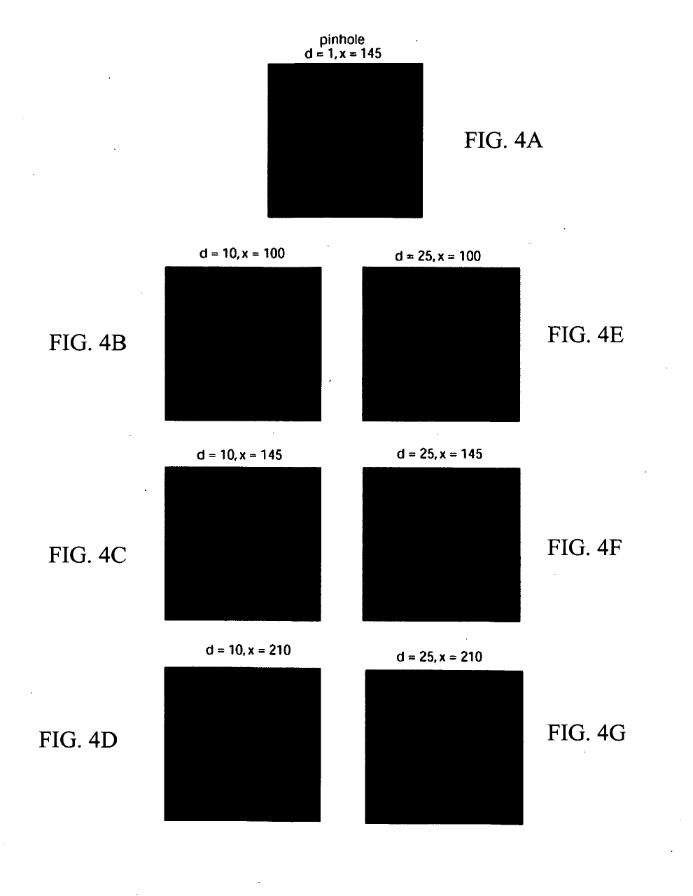

FIGS. 4A-4G show the results of an experiment in which the situation shown in FIG. 3 was simulated for various values of the aperture diameter and location of the aperture. In these figures, d is the diameter of the aperture stop and x determines the location of the aperture stop. The relative positions of the source objects 150A-150C, lens 110 and detector 120 are the same for all FIGS. 4A-4G. Only the aperture stop varies in position. The coordinate x=0 occurs at the image plane 120. The lens 110 is located at x=150. In FIGS. 4A, 4C and 4F, the stop is located at x=145 which is close to the lens, approximately as shown in FIG. 3. In FIGS. 4B and 4E, the stop is located at x=100, which is moved closer to the detector 120. In FIGS. 4D and 4G, the stop is located at x=210 on the other side of the lens 110.

FIG. 4A was produced with the smallest aperture diameter (d=1), essentially a pinhole. FIGS. 4B-4D were produced with a larger aperture diameter of d=10 at various values of x. FIGS. 4E-4G were produced with the largest aperture diameter of d=25 at various values of x. In all cases, the lens was focused on the green square 150B. In the resulting images generated by backwards ray tracing, the image of the green square 150B always appeared sharp, as would be expected. However, the sharpness of the red square 150A varied depending on the depth of field of the system. For the pinhole aperture, the system had a large depth of field and the red square 150A was also in focus. For larger apertures, the depth of field decreased and the red square 150A fell out of focus.

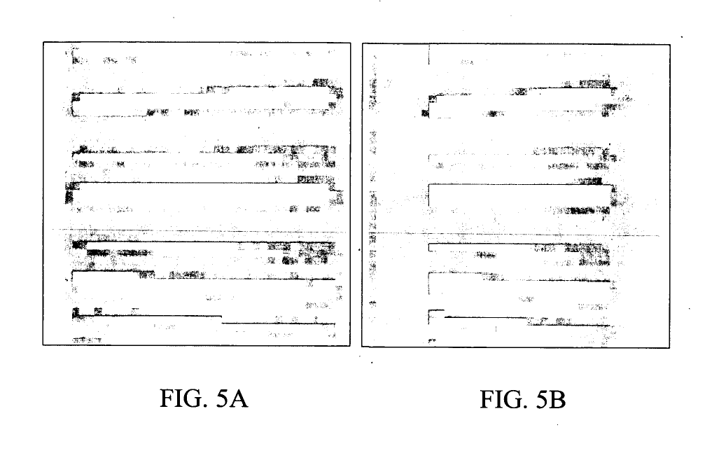

FIGS. 5A-5B show the results of a different simulation in which pseudo-barcodes were used as the source in FIG. 3. The barcodes were tipped 45° (FIG. 5A) and 60° (FIG. 5B) in depth, away from the principal axis (line of sight) of the lens. In both FIGS. 5A and 5B, the left sides of the barcodes are closer to the viewer and the right sides are farther away. Note that due to the limited depth of field of the optical system, the sections closer and farther away are blurry. In this example, each pixel was based on roughly fifty rays from a simulated Gaussian point source, using Monte Carlo randomization of direction, within a cone subtended by the lens.

FIG. 3 shows a static source model but more complex models can also be used. For example, the source model may account for variations due to motion of the source, variations in a position of the source, variations in illumination of the source or noise variations in the source, to name a few. The spatial model of the source may have a statistical component to account for variability. The source can also be a class of sources (e.g., the class of barcodes). The spatial model could include multiple members of the class (e.g., a representative sampling of barcodes). In one approach, the model of the source includes a three-dimensional computer-generated model. Computer-generated models are often ray traced in order to render them. The same techniques can be used to carry out the backwards ray trace.

In most scenarios, the universe of all possible source objects to be imaged is naturally constrained by the application. For instance, this universe of objects may be tightly constrained as in the case of a barcode reading system, or rather unconstrained as in the case of a general purpose consumer camera. Be it large or small, the boundedness of this space can offer important prior information for the system designer. For instance, knowing that the source is a binary level scanned document provides powerful constraints and information to the digital image processing subsystem in particular where one might implement the nonlinear stage of binarization of the final digital image.

Information used to produce the spatial model of the source 150 may take several forms. The designer may possess detailed information about the three-dimensional geometry of the scene under consideration. Such information is commonly used to constrain the optics used in an imaging system. For instance, the optical designer typically desires to match the depth of focus of the optics with the expected depth of field of the scene in question to produce an image free from defocus related optical aberrations. The optical designer, however, typically satisfies only very generic geometric constraints such as the bounding box of expected object depth. With more specific depth related information at his/her disposal, the system designer is capable of developing better designs for imaging systems.

The spatially varying luminance properties of the scene may also be used to model the source 150. For instance, when dealing with text or textual document images, the designer may have information relating to the language of the imaged text, or that the signal represents a binary source, etc. Statistical models of the source might be extracted from a corpus of scanned documents representative of those to be scanned by the fielded system or modeled from physical first principles. This knowledge can be especially useful in designing the digital image processing subsystem. Many image processing techniques rely on prior information regarding the contents of the scene under observation as imaged by an idealized imaging system. Note that this prior information may be derived from physical first principles or learned from a large collection of data. In one approach, a high quality imaging system captures data under a variety of imaging scenarios in an effort to learn the underlying statistics of the scene.

Moving now to the optical subsystem 110, the overall goal of a traditional lens designer is to choose the set of optical design parameters θₒ to produce an optical subsystem with minimal wavefront error while satisfying other constraints such as minimum element edge width, minimum element spacing, etc. Since aberrations cannot be removed completely, the job of the traditional lens designer is to find a good balance between the different aberrations for the given application, costs, and related constraints. To accomplish this, the lens designer typically uses optical design software to vary the optical design in a manner that directly minimizes a merit function based on the aberrations or wavefront error.

Unfortunately, aberrations can be reduced only so much in a lens system of a given complexity (e.g., limited to a specific number of elements). However, in many cases, certain aberrations are more correctable by the digital image processing subsystem than others. The end-to-end design approach typically takes advantage of this, while the traditional lens design approach typically does not. To oversimplify for purposes of illustrating this point, assume that all aberrations can be rated according to their correctability via image processing techniques. The aberrations at the correctable end of the scale can be mostly or fully compensated by the digital image processing subsystem while those at the non-correctable end of the scale cannot. In a traditional design, the distinction between correctable and non-correctable aberrations is not recognized. Instead, the optical subsystem is designed to create an intermediate optical image of high image quality. Thus, for example, the lens system may be designed to reduce correctable and non-correctable aberrations equally to some moderate level. During subsequent digital image processing, the correctable aberrations are further reduced to a lower level digitally, but the non-correctable aberrations remain at their moderate level. Furthermore, correctability can vary significantly depending on the characteristics of the source, which typically is not accounted for in traditional approaches to designing optical subsystems.

In contrast, in the end-to-end design approach, it is recognized that the correctable aberrations can be compensated for by the digital image processing subsystem. Thus, the optical subsystem emphasizes reduction of those aberrations which are difficult to correct during subsequent image processing. The intermediate optical image may contain a lower level of non-correctable aberrations and a higher level of correctable aberrations. As a result, the intermediate optical image may be of lower image quality due to the higher level of these correctable aberrations. However, these are subsequently reduced by the digital image processing subsystem to a lower level so that the overall electro-optic imaging system has high performance. The end-to-end approach allows the designer to allocate correction between the various subsystems. For example, if digital image processing is inexpensive compared to lenses, the designer may select a simple but low performance optical subsystem followed by a complicated digital image processing subsystem.

Consider now the digital image processing subsystem 130. There exists a wide range of possible image processing techniques for improving performance of the electro-optic imaging system and it is not feasible to discuss here all possible image processing techniques. In the following example, the digital image processing subsystem uses techniques aimed at restoring the signal degraded by the point spread function (PSF). Furthermore, the restoration problem is approached from an estimation theoretic perspective in this example.

In general, there exists a wide range of possible restoration approaches that can be used to restore a signal s (e.g., the actual source 150 in FIG. 3) from the observed signal y (e.g., the estimated image based on backwards ray tracing), ranging from simple linear filters to iterative nonlinear techniques. The following examples describe certain techniques that each seek an optimum to well-defined performance measures and that exhibit predictable performance. In addition, while the following examples are based on post-processing performance metrics that compare ideal and actual images, other implementations might seek to optimize some empirical or nonanalytic measure, for instance the recognition accuracy in optical character recognition or in a barcode reader.

One class of restoration techniques is based on linear processes. These are generally simple to analyze formally and easy to implement in an actual system. In the linear framework, the original signal is estimated using a linear operator of the form:
ŝ=Ry. (1)
In this example, the minimum mean square error (MMSE) is used as the Lyapunov or target function. Referring to FIG. 1, the electro-optic imaging system 100 is optimized such that the sum of the squared deviations between an ideal image 155 and the actual digital image 180 is minimized. Here, the ideal image is the bandlimited, noise-free digital image that would arise from a theoretical pinhole imaging system with sufficient illumination and in the absence of diffraction. Thus, the goal is to find the filter matrix R satisfying

$${min}_{R} {ɛ}_{n , s} [ {‖ R y - s ‖}^{2} ] , \qquad ( 2 )$$

where the subscript of the expectation operator ε represents an expectation taken over the random noise n and the (assumed) stationary random signal s. The MMSE filtering approach requires no assumptions about the statistical properties of the underlying signal or noise models other than their respective means and covariance structures. Under the assumption that the noise and the signal are uncorrelated, the ideal linear restoration matrix is given by
R=CₛH^{T}[HCₛH^{T}+Cₙ]⁻¹ (3)
where Cₛ and Cₙ represent the covariance matrices of the signal and the noise respectively. The per-pixel MSE performance is predicted by such a system using
1/N Tr [(RH−I)Cₛ(RH−I)^{T}+RCₙR]. (4)
where Tr[ ] is the trace operator and N is the number of pixels in the entire image.

Utilizing nonlinear restoration techniques widens the space of possible post-processing performance metrics. For instance, the class of nonlinear iterative restoration techniques is often statistically motivated, such as Maximum Likelihood (ML) or Maximum A-Posteriori (MAP). Such approaches have the benefit of being asymptotically unbiased with minimum error variance, which are stronger properties than MMSE.

For instance, assuming that the signal s is a deterministic, yet unknown signal, the ML estimate of the signal satisfies

$$\hat{s} = {max}_{S} L ( y \vert s ) , \qquad ( 5 )$$

where L(y|s) is the statistical likelihood function for the observed data. Since it is assumed in this particular example that the additive noise in the signal model is Gaussian, the ML cost function reduces to a least squares (LS) objective function

$$\begin{matrix}\hat{s} = {min}_{S} {‖ y - H s ‖}^{2} & ( 6 ) \\ = {[ {H}^{T} H ]}^{- 1} {H}^{T} y . & ( 7 )\end{matrix}$$

For signals of large dimension (i.e., large numbers of pixels), it may become prohibitive to explicitly construct these matrices. Often, iterative methods are utilized to minimize Eqn. 6 eliminating the need to explicitly construct the matrices. In many situations (for instance severe defocus), the operator H is rank-deficient leading to unstable solutions. In such cases, additional information, such as source power spectral density information or source functional smoothness, can be used to constrain the space of solutions.

When statistical prior information exists about the unknown signal, the MAP cost function becomes

$$\hat{s} = {min}_{S} {‖ y - H ( τ ) s ‖}^{2} + ψ C ( s ) \qquad ( 8 )$$

where C(s) represents the prior information about the unknown signal and ψ represents a Lagrangian-type relative weighting between the data objective function and prior information. Cost functions of this form may not permit analytic solutions as in Eqn. 7. The Cramer-Rao inequality could be used to bound as well as to predict asymptotically the nonlinear estimator performance.

Although the detailed description contains many specifics, these should not be construed as limiting the scope of the invention but merely as illustrating different examples and aspects of the invention. It should be appreciated that the scope of the invention includes other embodiments not discussed in as much detail above. Various other modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method for designing an electro-optic imaging system for imaging a source, the electro-optic imaging system including an optical subsystem, a detector subsystem and a digital image processing subsystem, the method comprising:
modeling propagation of signal from the source through the optical subsystem, the detector subsystem and the digital image processing subsystem, where the step of modeling propagation includes:
tracing rays from the detector subsystem backwards through the optical subsystem to the source; and
modeling propagation of signal from the source to the detector subsystem based on the backwards ray trace and also based on a spatial model of the source; and
designing the optical subsystem based directly on a post-processing performance metric that is a function of the modeled propagation.

2. The method of claim 1 where the spatial model of the source is a three-dimensional model of the source.

3. The method of claim 2 where the three-dimensional model of the source is a computer-generated model of the source.

4. The method of claim 1 where the spatial model of the source accounts for variations due to motion of the source.

5. The method of claim 1 where the spatial model of the source accounts for variations in a position of the source.

6. The method of claim 1 where the spatial model of the source accounts for variations in illumination of the source.

7. The method of claim 1 where the spatial model of the source accounts for noise variations in the source.

8. The method of claim 1 where the source is binary and the spatial model of the source accounts for the binary nature of the source.

9. The method of claim 1 where the spatial model includes a statistical model accounting for variations in the source.

10. The method of claim 1 where:
the detector subsystem includes an array of detectors, the detectors in the array producing pixels of an image; and
the step of modeling propagation includes, for detector(s) that correspond to a pixel in the image:
tracing rays from the detector(s) backwards through the optical subsystem to the source; and
estimating the pixel produced by the detector(s) based on the backwards ray trace and on a spatial model of the source.

11. The method of claim 10 where the step of estimating the pixel produced by the detector(s) includes:
determining source points intersected by rays traced backwards from the detector(s), based on the spatial model of the source;
determining image contributions from the intersected source points; and
combining the image contributions to estimate the pixel produced by the detector(s).

12. The method of claim 11 where the step of combining the image contributions includes:
forming a weighted average of the image contributions.

13. The method of claim 10 where the spatial model includes a statistical model accounting for variations in the source, and the step of estimating the pixel produced by the detector(s) is based on the statistical model.

14. The method of claim 10 where the spatial model of the source is a three-dimensional model of the source.

15. The method of claim 1 where the step of designing the optical subsystem is performed without requiring a direct optimization of an image quality of an intermediate optical image of the source formed by the optical subsystem.

16. The method of claim 1 where the post-processing performance metric is a mean square error between an ideal image of the source and an image predicted by the modeled propagation of the source through the optical subsystem, the detector subsystem and the digital image processing subsystem.

17. The method of claim 1 where the designed optical subsystem forms an intermediate optical image that is significantly worse in image quality than that formed by an optical subsystem designed to optimize the image quality of the intermediate optical image.

18. The method of claim 1 where the step of designing the optical subsystem is subject to one or more non-imaging constraints.

19. The method of claim 1 where the step of designing the optical subsystem comprises jointly designing the optical subsystem and the digital image processing subsystem based directly on the post-processing performance metric.

20. The method of claim 19 where the step of jointly designing the optical subsystem and the digital image processing subsystem is limited to linear digital image processing subsystems.

21. A computer readable medium containing instructions to cause a processor to design an optical subsystem of an electro-optic imaging system by executing the following steps:
modeling propagation of signal from the source through the optical subsystem, the detector subsystem and the digital image processing subsystem, where the step of modeling propagation includes:
tracing rays from the detector subsystem backwards through the optical subsystem to the source; and
modeling propagation of signal from the source to the detector subsystem based on the backwards ray trace and on a spatial model of the source; and
designing the optical subsystem based directly on a post-processing performance metric that is a function of the modeled propagation.

22. The computer readable medium of claim 21 where the spatial model of the source is a three-dimensional model of the source.

23. The computer readable medium of claim 21 where the spatial model of the source accounts for variations in the source.

24. The computer readable medium of claim 21 where the spatial model includes a statistical model accounting for variations in the source.

25. The computer readable medium of claim 21 where:
the detector subsystem includes an array of detectors, the detectors in the array producing pixels of an image; and
the step of modeling propagation includes, for detector(s) that correspond to a pixel in the image:
tracing rays from the detector(s) backwards through the optical subsystem to the source; and
estimating the pixel produced by the detector(s) based on the backwards ray trace and on a spatial model of the source.

26. The computer readable medium of claim 25 where the step of estimating the pixel produced by the detector(s) includes:
determining source points intersected by rays traced backwards from the detector(s), based on the spatial model of the source;
determining image contributions from the intersected source points; and
combining the image contributions to estimate the pixel produced by the detector(s).

27. The computer readable medium of claim 26 where the step of combining the image contributions includes:
forming a weighted average of the image contributions.

28. The computer readable medium of claim 21 where the step of designing the optical subsystem is performed without requiring a direct optimization of an image quality of an intermediate optical image of the source formed by the optical subsystem.

29. The computer readable medium of claim 21 where the post-processing performance metric is a mean square error between an ideal image of the source and an image predicted by the modeled propagation of the source through the optical subsystem, the detector subsystem and the digital image processing subsystem.

30. The computer readable medium of claim 21 where the designed optical subsystem forms an intermediate optical image that is significantly worse in image quality than that formed by an optical subsystem designed to optimize the image quality of the intermediate optical image.

31. The computer readable medium of claim 21 where the step of designing the optical subsystem is subject to one or more non-imaging constraints.

32. The computer readable medium of claim 21 where the step of designing the optical subsystem comprises jointly designing the optical subsystem and the digital image processing subsystem based directly on the post-processing performance metric.

33. An optical subsystem that is part of an electro-optic imaging system, the electro-optic imaging system further comprising a detector subsystem and a digital image processing subsystem, the optical subsystem designed by the process of:
modeling propagation of signal from the source through the optical subsystem, the detector subsystem and the digital image processing subsystem, where the step of modeling propagation includes:
tracing rays from the detector subsystem backwards through the optical subsystem to the source; and
modeling propagation of signal from the source to the detector subsystem based on the backwards ray trace and on a spatial model of the source; and
designing the optical subsystem based directly on a post-processing performance metric that is a function of the modeled propagation.
